(19) United States
(12) Patent Application Publication
(10) Pub. No.: US 2018/0302377 A1
(43) Pub. Date: Oct. 18, 2018

(54) MANAGING ACCESS SETTINGS FOR A NETWORK GATEWAY

(71) Applicant: Lenovo (Singapore) Pte. Ltd., New Tech Park (SG)

(72) Inventors: Amy Leigh Rose, Chapel Hill, NC (US); Jennifer Lee-Baron, Morrisville, NC (US); Nathan J. Peterson, Oxford, NC (US); John Scott Crowe, Durham, NC (US); Bryan Lyod Young, Tualatin, OR (US); Gary David Cudak, Wake Forest, NC (US)

(21) Appl. No.: 15/485,328

(22) Filed: Apr. 12, 2017

(51) Int. Cl. H04L 29/06; H04L 12/66; H04W 12/06

(52) U.S. Cl. CPC H04L 63/0254; H04L 12/66; G06K 9/00255; H04L 63/0861; H04W 12/06; H04L 63/108

(57) ABSTRACT

Methods, devices and program products are provided for collecting activity data concerning a local environment from a device associated with the local environment. The method determines, using a processor, an activity state associated with a local environment based on the activity data collected by the device. The method manages, using the processor, an access setting associated with a network port of a network gateway into the local environment based on the activity state.

### BACKGROUND

Network routers, firewalls and the like are provided with various types of ports that support different types of data traffic to and from a network (e.g., for local and private area networks). Port forwarding or port mapping is an example of an application of network address translation that redirects a communication request from one address and port number combination to another address and port number, while data packets are traversing a network gateway, such as a router or firewall. Port forwarding or port mapping may be used in connection with allowing computing devices outside of a network to obtain access to services that are made available on a host computing device located within a protected network. For example, one or more ports of the router may be utilized to route data traffic to and from a local computing device that is operating as a server. Other examples of applications may include running a public HTTP server within a private local area network (LAN), permitting access to a host on the private local area network, permitting FTP access to a host on a private LAN, running a publicly available gaming server within a private LAN and the like. As another example, a user may desire to use a remote desktop application to access a computing device (e.g., home computer or office computer) when outside of the network.

Routers and firewalls offer various levels of access to protect computing devices within a network from various types of cyber-attacks. To set access settings for a router or firewall, a user must login to a router and manually set the access settings associated with all or individual ports. The access settings may permit or block all traffic to a particular port, certain types of traffic to a particular network port and the like. While it is desirable to maintain a high level of security in connection with offering access to a network, the desire for security is balanced with the user's desire for access to computing devices within the network. For example, when a user is remote from a local network, the user prefers to have full access to computing devices within the network (e.g., such as through the use of a remote desktop utility).

However, once the access settings are manual set, the access settings remain static until manually changed. Accordingly, when a user logs into a router manager and enables or disables one or more ports of the router, the access settings remain enabled or disabled until the user logs into the router manager again and changes the access setting. As another example, some routers today allow access settings to be programmed for certain periods of time. For example, a higher level of security may be programmed to take effect for certain times of day. However, an individual's usage pattern may not necessarily fit preprogrammed time periods and thus the user may be blocked from certain types of access during the preprogrammed time periods.

A need remains for methods and devices that dynamically manage access settings for network gateways.

### SUMMARY

In accordance with embodiments herein a method is provided, comprising collecting activity data concerning a local environment from a device associated with the local environment. The method determines, using a processor, an activity state associated with a local environment based on the activity data collected by the device. The method manages, using the processor, an access setting associated with a network port of a network gateway into the local environment based on the activity state.

Optionally, the managing may further comprise changing the access setting between first and second access levels based on the activity data. The device may represent a sensor to monitor at least a portion of the local environment and may provide, as the activity data, an indication of whether one or more individuals are present in the local environment. The device may represent a portable device to provide, as the activity data, sleep state information for a user associated with the wearable device. The managing may further comprise disabling the network port when the activity state corresponds to a sleep state.

Optionally, the method may further comprise accessing one or more rules that may define the access setting associated with the network port based on the activity state. The method may further comprise receiving incoming data traffic from an external source. The data traffic may be directed to the network port of the network gateway into the local environment, and may determine whether to block the data traffic based on the access setting. The network gateway may include first and second ports. The managing may comprise individually managing the first and second ports to have different access settings based on the activity state.

In accordance with embodiments herein an apparatus is provided, comprising a network port into a local environment. The network port receives data traffic directed to one or more computing devices within a local environment. Memory stores program instructions. A processor, in response to execution of the program instructions, to: collect activity data concerning the local environment, determine an activity state associated with a local environment based on the activity data collected by the device and manage an access setting for the network port into the local environment based on the activity state.

Optionally, the apparatus may further comprise a wireless router, wherein the network port may represent a network port on the wireless router. The processor, in response to execution of the program instructions, may route incoming data traffic through the network port to a predetermined computing device within the local environment. The device may represent a portable device that may provide, as the activity data, sleep state information for a user associated with the wearable device. The device may represent a sensor to monitor at least a portion of the local environment and may provide, as the activity data, an indication of whether one or more individuals are present in the local environment.

Optionally, the processor, in response to execution of the program instructions, may change the access setting between first and second access levels based on the activity data. The processor, in response to execution of the program instructions, may disable the network port when the activity state corresponds to a sleep state. The memory may store one or more rules that define the access setting for the network port based on the activity state.

In accordance with embodiments herein, a computer program product is provided comprising a non-signal computer readable storage medium comprising computer executable code to perform collecting activity data concerning a local environment from a device associated with the local environment, determining, using a processor, an activity state associated with a local environment based on the activity data collected by the device; and managing, using the processor, an access setting associated with a network port of a network gateway into the local environment based on the activity state.

Optionally, the managing may further comprise changing the access setting between first and second access levels based on the activity data. The device may represent a portable device to provide, as the activity data, sleep state information for a user associated with the wearable device. The managing may further comprise disabling the network port when the activity state corresponds to a sleep state.

### BRIEF DESCRIPTION OF THE DRAWINGS

FIG. 1 is a functional block diagram illustrating a secure communication system in a wireless environment, in accordance with an embodiment herein.

FIG. 2 illustrates an example of a rule database and tracker utilized in connection with an embodiment herein.

FIG. 3 illustrates a process for managing access settings implemented in connection with embodiments herein.

FIG. 4 is a block diagram of components of network gateway in accordance with embodiments herein.

FIG. 5 is a block diagram of components of computing device, and devices, respectively, in accordance with an embodiment.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “gateway”, as used throughout, shall include (but not be limited to) routers, firewalls, cable modem, cable access point and other devices that afford access to a local environment and offer one or more access settings to be adjusted in connection with the access. The local environment may represent a local area network, a private or public area network, a wide-area network or otherwise.

The term “device”, as used throughout, shall include (but not be limited to) portable devices, sensors, Fitbit device, smart phone, smart watch and computing devices. The computing device can be a laptop computer, tablet computer, netbook computer, personal computer (PC), a desktop computer, a personal digital assistant (PDA), a smart phone, or any programmable electronic device capable of wirelessly communicating with gateway, and supporting the desired functionality, home appliance, such as a thermostat, television, sterio, stove, refrigerator.

The terms “communications content”, and “content,” as used throughout, shall generally refer to any and all textual, audio or video information or data conveyed to or from a device during a communications event. The content may represent various types of incoming and outgoing textual, audio, graphical and video content including, but not limited to, calendar updates, email, text messages, voicemail, incoming phone calls as well as other content in connection with social media and the like.

The term “network port”, as used throughout, shall refer to a hardware or software end point of communications at a network gateway. Network ports identify specific processes and/or types of network services. A network port is associated with an Internet protocol (IP) address of a gateway and the protocol type of the communication, and completes the destination or origination address of a communication session. A network port may be identified for each address and protocol by a 16-bit number, commonly known as the port number. Specific port numbers may be used to identify specific services supported by a gateway.

Non-limiting examples of “access settings” for a network port include permitting or blocking some or all traffic to a particular port, certain types of traffic to a particular network port and the like. An access setting may include turning a router on or off. An access setting may be applied in connection with individuals (e.g., user specific), groups of individuals or everyone. Additional non-limiting examples of access settings may include enabling or disabling a corresponding network port or ports. Another example of the access setting may represent changing filters applied to incoming Internet content. For example, when the network owner (e.g., a parent) is identified to be sleeping (or gone to bed), an Internet content filter may be increased or applied to block certain types of content. For example, a filter may be applied to block PG-13 and adult content. Additionally or alternatively, when the network owner or other specific individual is identified to be sleeping, the access settings may block all incoming streaming video, such as to prevent watching Netflix® video or any other video/television content after the parents have gone to bed. Other examples of access settings may relate to network port forwarding or network port mapping. As another example, access settings to may be adjusted in connection with performing remote desktop functions.

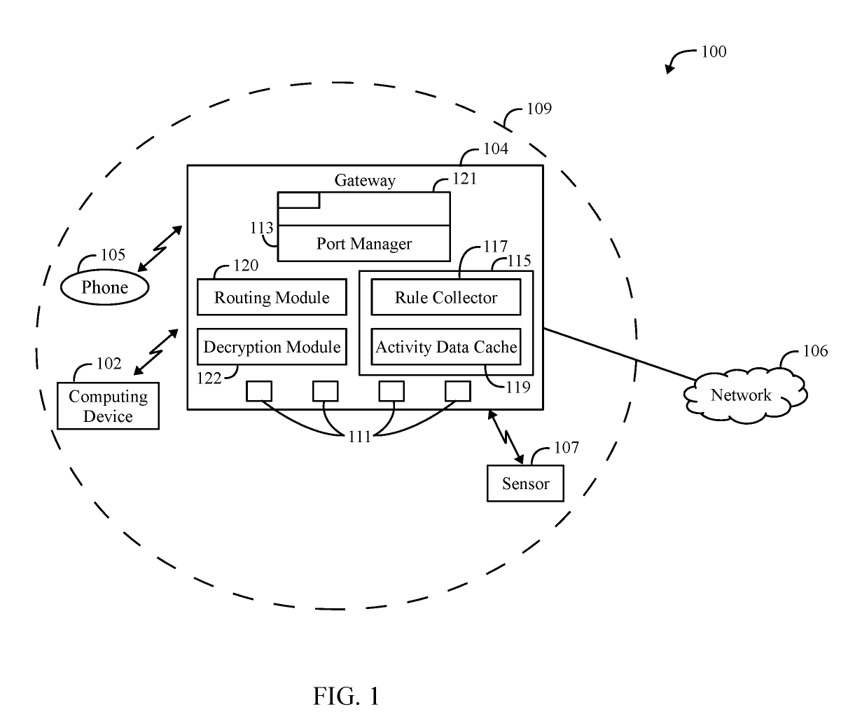

FIG. 1 is a functional block diagram illustrating a secure communication system 100 in a wireless environment, in accordance with an embodiment. In an embodiment, secure communication system 100 includes one or more computing devices 102, one or more network gateways 104, one or more devices 105 and network 106. The devices 105 may represent portable devices and/or sensors 107. In an embodiment, network gateway 104 defines a local environment 109. As an example, the network gateway 104 may represent a router that creates a wireless local area network (WLAN) in accordance with the Institute of Electrical and Electronics Engineers (IEEE) 802.11 protocol. Computing device 102 connects to the WLAN in accordance to an IEEE 802.11 compatible security algorithm, such as, for example, Wi-Fi Protected Access (WPA), Wi-Fi Protected Access II (WPA2), or Wired Equivalent Privacy (WEP). Network gateway 104 can provide access to network 106 for wireless devices connected to the wireless router, such as computing device 102, directly via bridging functionality integral to network gateway 104, or in conjunction with bridging functionality, not shown, that is accessible by network gateway 104. Network 106 can be, for example, a local area network (LAN), a wide area network (WAN) such as the Internet, or a combination of the two, and can include wired, wireless, or fiber optic connections. Optionally, the computing device 102 and the device 105 may be coupled to the network gateway 104 through a wired connection.

The network gateway 104 includes multiple network ports 111 that have associated processes and/or types of network services. The network ports 111 are associated with different IP addresses of the gateway 104 and support corresponding protocol types. The network ports 111 are separately addressed by incoming and outgoing data traffic, such as through destination or origination addresses in data packets conveyed during a communication session.

The gateway 104 includes a port manager 113, defined by one or more processors 121 executing program instructions, that performs operations described herein. The port manager 113 collects activity data from one or more devices 105. The activity data concerns activity of interest within the local environment 109. The port manager 113 determines an activity state associated with the local environment 109 based on the activity data collected by the device(s) 105. The port manager 113 manages port access settings for the network ports 111 of the gateway 104 based on the activity state. The access settings may be modified based on security considerations or based on other factors related to providing access to the local environment 109 through network ports 111 of the gateway 104. For example, depending on the desired level of secure communications, different access settings can be applied. For example, in an exemplary embodiment where a high level of security is desired, one or more network ports 111 may be disabled.

The gateway 104 may include or have access to memory 115 that stores, among other things, a collection of rules 117. The rules 117 define access settings to be implemented in connection with different activity states. The rules 117 may also define one or more network ports 111 to which a particular access setting is to be applied based on a corresponding activity state. The rules 117 may be “universal” in that an access setting may be applied to a group or all network ports 111 when a corresponding activity state is identified. Additionally or alternatively, the rules may be network port specific, by defining individual access settings to be applied to specific network ports 111 when the corresponding activity state is identified. The collection of rules 117 may be defined and/or updated in various manners. For example, the collection of rules 117 may be provided with a gateway 104 at the time of manufacture, installation, or otherwise. Additionally or alternatively, the rules 117 may be added by a user when setting up a local environment 109 and/or when setting up a gateway 104.

In an embodiment, network gateway 104, includes a routing module 120 and an optional decryption module 122. The routing module 120 operates to provide wireless routing connectivity for wireless devices connected to network gateway 104. For example, messages between computing device 102 and other computing devices directly connected to network gateway 104 can be routed directly by the wireless router. Messages between, for example, computing device 102 and external computing devices accessible via network 106 are routed to network 106. The optional decryption module 122 operates to receive encrypted data traffic from an external computing device, decrypt the data traffic, and transmit the decrypted data traffic to one or more of the computing devices 102 in the local environment 109.

Although the present embodiment includes a wireless router, in general, network gateway 104 can be any wireless device that can establish a wireless channel to computing device 102, and includes at least the functionality of decryption module 122. For example, the wireless device can be a computing device, such as a laptop or desktop computer, with ad hoc wireless network capability. When the wireless device and computing device 102 are within wireless range of each other, and a wireless channel has been established between them, the functionality described above in which computing device 102 sends the encrypted email message to the wireless device for decryption can be performed.

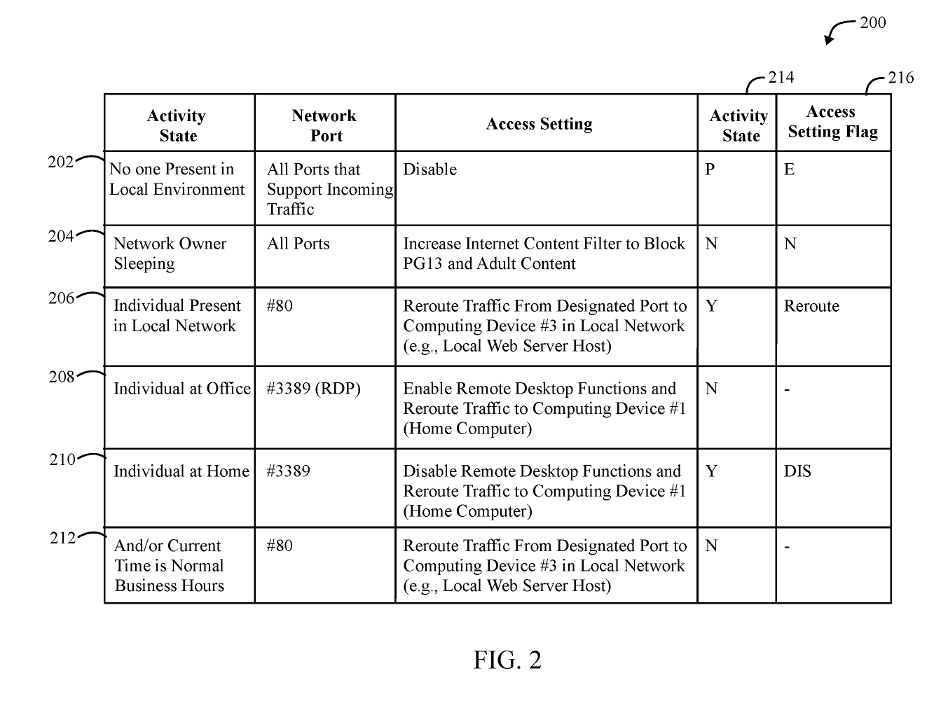

FIG. 2 illustrates an example of a rule database and tracker 200 utilized in connection with an embodiment herein. The rule database and tracker includes a collection of rules 202-212, and tracking information such as the current activity state 214 and an access flag 216, that may be utilized in connection with an embodiment herein. The rules may designate different activity states, one or more network ports associated with the rule and the access setting to be applied in connection with the rule. For example, a rule 202 may relate to changing an access setting based on the presence of one or more individuals within the local environment. The rule 202 is based on activity data that is indicative of whether individuals are present in the local environment. For example, the activity data may correspond to sensor data received from a device 105, such as a motion detector, an infrared sensor, a camera, or another electronic device in the local network.

When using a motion detector, the sensor data indicates whether motion has been identified within the local environment. When a camera is used as an activity sensing device, the camera may provide activity data indicating the presence of any individual, without particular identification of a unique individual. Additionally or alternatively, the camera may include facial recognition software that identifies particular individuals that may be used to indicate activity data related to a particular individual. For example, the camera may return activity data that includes the unique identification of an individual, as well as the time at which the individual was identified. Identification of particular individuals may be of interest in connection with adjusting access settings that are user specific.

As another example, the activity data may correspond to the data received from a cellular phone, smart watch, Fit Bit® device and the like (all referred to as devices 105). The phone, watch, fit bit device may communicate with the gateway 104 when physically located within a range of the gateway 104. The presence of the phone, watch, fit bit device, etc., may be treated as an indirect indicator or proxy indicating that an individual who owns or controls the device is within the range of the local environment. As another example, the device 105 may correspond to a home appliance, such as a thermostat, television, stereo, stove, refrigerator, etc. When the home appliance is being utilized or adjusted by an individual, the home appliance may provide activity data to the gateway 104.

The collection of rules in FIG. 2 also includes network port designators to indicate one or more network ports to which a corresponding access setting should be applied. In the example of FIG. 2, rule 202 designates all of the network ports that support incoming traffic, while ruled 204 designates all network ports, and rules 206-212 designate specific network ports (e.g., network port 80 and network port #3389). It is recognized that alternative combinations of network ports may be utilized. Additionally or alternatively, one or more rules may not designate particular network ports.

The collection of rules in FIG. 2 includes access settings to be applied in connection with each rule 202-212. Non-limiting examples of access settings may include enabling or disabling a corresponding network port or ports. Another example of the access setting may represent changing filters applied to incoming Internet content. For example, rule 204 indicates that, when the network owner (e.g., a parent) is identified to be sleeping (or gone to bed), an Internet content filter may be increased or applied to block certain types of content. For example, a filter may be applied to block PG-13 and adult content. Additionally or alternatively, when the network owner or other specific individual is identified to be sleeping, the access settings may block all incoming streaming video, such as to prevent watching Netflix° video or any other video/television content after the parents have gone to bed. As noted herein, the gateway 104 may include or correspond to a cable modem or cable access point. Accordingly, in connection with the present example, rule 204 may block all incoming cable programming at the cable modem or cable access point, in order to prevent watching television after the parents are gone to bed.

Other examples of access settings may relate to network port forwarding or network port mapping. For example, rule 206 may be activated based on whether an individual is present in the local environment. When the individual is present in the local environment, the gateway 104 may forward all incoming data traffic that is received at a designated network port (e.g., network port 80) to a corresponding individual computing device (e.g., computing device number 3). As one example, network port forwarding based on user presence may be of interest when a local computing device is used as a Web server host. The user may only desire the local computing device to operate as a local Web server host when the individual is present in the home (and/or when the individual is not present in the home). Additionally or alternatively, a rule may be based on time parameters. For example, during certain times of day, one access setting may be applied, while a different access setting is applied at other times a day. As illustrated in rule 212, when the current time of day is during normal business hours, data traffic received at network port 80 is rerouted to a particular computing device (e.g., a device operating as a web server host).

As another example, access settings to may be adjusted in connection with performing remote desktop functions. For example, rules 208 and 210 may be applied based on the location of an individual. When the activity data indicates that the individual is at his/her office (rule 208), a remote desktop function is enabled and traffic received at a related network port (e.g., network port #3389) is rerouted to the individual's home computer (designated as computing device #1). When the activity data indicates that the individual is at his/her home (rule 210), a remote desktop function is disabled and traffic received at a related network port that supports a remote desktop function (e.g., network port #3389) is blocked/denied and is not rerouted to the individual's home computer.

FIG. 2 also illustrates tracking information within the rule database and tracker 200. While various types of tracking information may be maintained, in the present example, the tracking information includes a current activity state 214 and access flags 216. As shown in FIG. 2, in connection with rule 202, the current activity state 214 indicates that an individual is present (P) and that rule number 202 is enabled (E) as denoted by access flag 216. With respect to rule 204, the current activity state 214 indicates no (N) to indicate that the owner is not sleeping, and thus the access setting has not (N) increased the Internet content filter to block PG-13 and adult content. With respect to rule 206, the current activity state indicates yes (Y) representing that the individual is present in the local network. Accordingly, a rerouting rule reroutes incoming traffic received at network port #80 to a computing device #3. With respect to rule 208, the individual is not at his/her office (N), and thus the remote desktop function is not enabled. With respect to rule 210, the individual is at home (Y), and thus network port #3389 is disabled (DIS). With respect to rule 212, the current time is not during normal business hours (N) and thus the rerouting rule has not been applied.

It is recognized that more than one rule may be applied to a common network port. When more than one rule applies to a common network port, the access settings may be managed in various manners. For example, the rules may be prioritized such that one rule takes priority over another rule. The priority may be determined in various manners. For example, the user may designate the priority as a separate element of the rule database. Alternatively, the user may designate the priority based on the order in which the rules are arranged within the rule database, such that the first or last rule applied to a network port will control. Alternatively, access settings may be assigned various priorities. For example, an access setting concerning filtering of adult content may take priority over any and all other rules. As another example, a rule blocking incoming data traffic after a certain time of day (e.g., after 10 o'clock at night) may take priority over other rules that may otherwise enable one or more network ports For example, in FIG. 2, network port #80 has two rules applied thereto. The first rule 206 may be designated to take priority over rule 212. Additionally or alternatively, the access setting for a network port may be adjusted in accordance with the first or last rule encountered within the rule database, while any other rules applying to the same network port may be ignored.

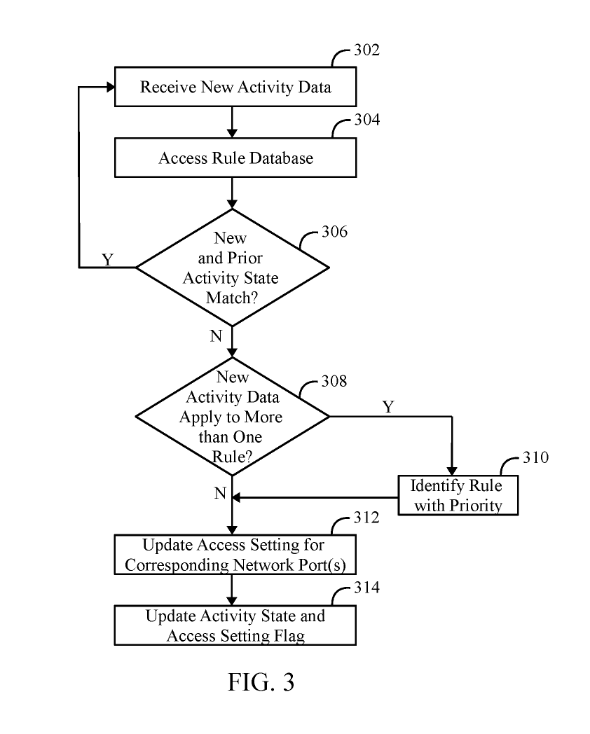

FIG. 3 illustrates a process for managing access settings implemented in connection with embodiments herein. At 302, one or more processors of the gateway 104 obtain new activity data. For example, the gateway 104 may step through a polling sequence to check each device 105 that has been designated to collect activity data. As another example, when the gateway 104 detects a Bluetooth signal from an individual phone or other wireless device 105, the gateway 104 may record the presence of the Bluetooth signal as the activity data that the user is present. The activity data may represent a presence of a device 105, such as a Bluetooth signal, a MAC address, etc. Optionally, the activity data may include activity information, such as movement by a Fitbit® device, and/or state information such as a change in a thermostat setting. Optionally, the gateway 104 may request updated motion information from a motion sensor, request a current image from a camera, and the like. Additionally or alternatively, the activity data may be pushed to the gateway 104 and saved in an activity data cache (119 in FIG. 1). At 302, the processor of the gateway 104 may review the current activity data stored in the activity data cache 119.

At 304, the one or more processors of the gateway 104 accesses the rule database and tracker 200 to obtain the tracking information associated with one or more rules. At 304, tracking information may be obtained only for rules associated with the newly updated activity data, or alternatively, tracking information may be obtained for all rules.

At 306, the one or more processors of the gateway 104 compare a new activity state, corresponding to the new activity data, with a previously recorded activity state. When the new and previously recorded activity states match, flow returns to 302. When the new and previously recorded activity states do not match, flow advances to 308 For example, with reference to FIG. 2, a motion sensor, smart phone, smart watch, or otherwise may be utilized to collect activity data, from which the processor determines that an individual is within the local environment. The processor of the gateway 104 accesses rule 210 to determine the previously recorded activity state. In the present example, the gateway 104 already determined that the individual was at home (Y). Given that the new activity state matches the previously recorded activity state, no change is warranted and flow returns to 302.

Optionally, the decision at 306 may be removed entirely and the complete process of FIG. 3 may be implemented every time new activity data is received, without regard for whether the previously recorded activity state matches the new activity state. It may be desirable to perform all of the operations of FIG. 3 to ensure that the rule database and tracker 200 accurately match the current access settings.

At the 308, the one or more processors of the gateway 104 determine whether the new activity data applies to more than one rule. When new activity data applies to more than one rule, flow branches to 310. At 310, the one or more processors of the gateway 104 determine if one rule takes priority over the other rule/rules that apply the new activity data. When one rule takes priority, the priority rule is acted upon at 312. When no rule takes priority, all rules that warrant update are acted upon at 312.

Returning to 308, when only one rule applies to the new activity data, flow advances to 312. At 312, the one or more processors of the gateway 104 updates the access settings for the one or more network ports associated with the current rule. At 314, the one or more processors of the gateway 104 update the tracking information to capture any changes made at 312. For example, the activity state 214 is updated to record the new activity data as the previously recorded activity data, and the access flag 216 is updated to reflect the current access setting to be applied to the corresponding one or more network ports.

The operations of FIG. 3 may be performed continuously, at predefined intervals, or in response to select criteria. For example, the operations of FIG. 3 may be performed when new activity data is received. For example, when an individual comes home (or otherwise enters a local environment), a device associated with the individual (smart phone, smart watch, fit that device, etc.) may establish a Bluetooth communication session with the gateway 104. When the gateway 104 identifies a Bluetooth connection request from a device, the gateway 104 may use the connection request as new activity data and implement the operations of FIG. 3. Additionally or alternatively, the gateway 104 may receive, as activity data, motion sensor signals from a motion detector, in response to which the gateway 104 updates the corresponding access settings.

Optionally, the gateway 104 may implement the operations of FIG. 3 in connection with receipt of select types of incoming data traffic. For example, when the gateway 104 receives incoming data traffic requesting a remote desktop application to be initiated, the gateway 104 may implement the operations of FIG. 3, in order to determine whether a corresponding activity state is appropriate to enable a remote desktop function. As another example, at certain times of day, the operations of FIG. 3 may be implemented. For example, the access settings may be updated at the beginning and ending of pre-recorded business hours, at a programmed bedtime and the like.

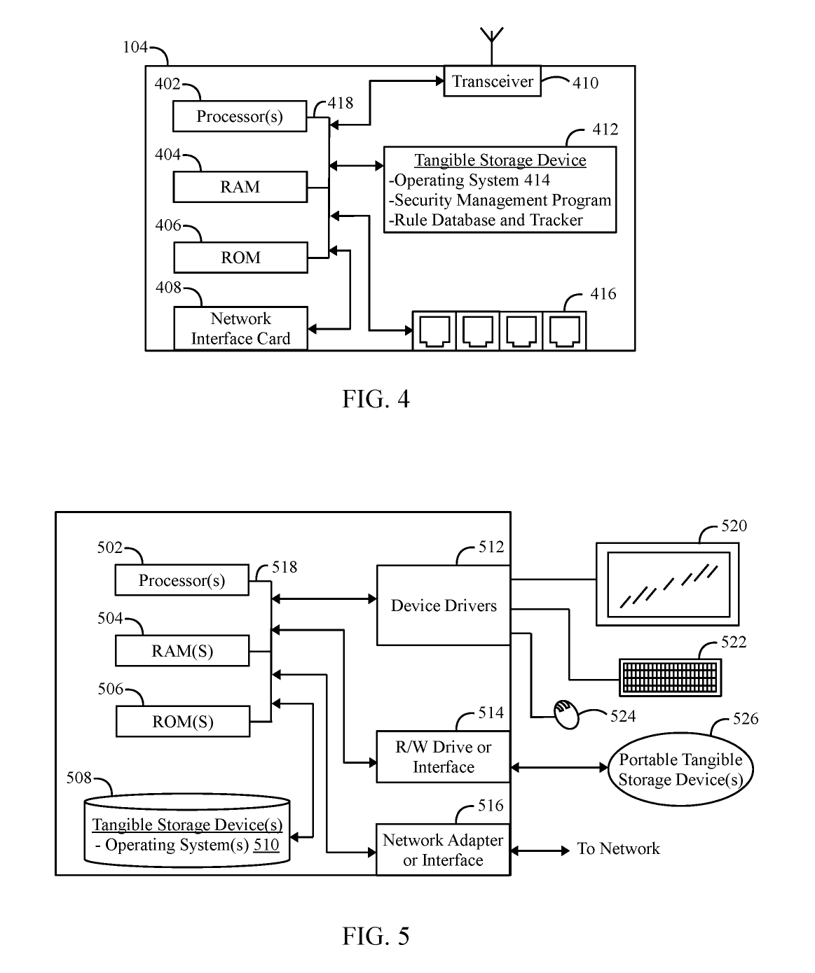

FIG. 4 is a block diagram of components of network gateway 104 in accordance with embodiments herein. The gateway 104 can include one or more processors 402, one or more computer-readable RAMs 404, one or more computer-readable ROMs 406, one or more tangible storage devices 412, a network interface card 408, a transceiver 410, and one or more network ports 416, all interconnected over a communications fabric 418. Communications fabric 418 can be implemented with any architecture designed for passing data and/or control information between processors (such as microprocessors, communications and network processors, etc.), system memory, peripheral devices, and any other hardware components within a system.

One or more operating systems 414, and rule database and track programs are stored on computer-readable tangible storage device 412 for execution or access by one or more processors 402 via one or more RAMs 404 (which typically include cache memory). In the illustrated embodiment, computer-readable tangible storage device 412 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

The network gateway 104 will typically include a network interface card 408, such as a TCP/IP adapter card. The programs on network gateway 104 can be downloaded to the wireless router from an external computer or external storage device via a network (for example, the Internet, a local area network or other, wide area network or wireless network) and network interface card 408. The programs can then be loaded into computer-readable tangible storage device 412. The network may comprise copper wires, optical fibers, wireless transmission, routers, firewalls, switches, gateway computers and/or edge servers.

FIG. 5 is a block diagram of components of computing device 102, and devices 105, respectively, in accordance with an embodiment. Computing device 102 and devices 105 can include one or more processors 502, one or more computer-readable RAMs 504, one or more computer-readable ROMs 506, one or more tangible storage devices 508, device drivers 512, read/write drive or interface 514, network adapter or interface 516, all interconnected over a communications fabric 518. Communications fabric 518 can be implemented with any architecture designed for passing data and/or control information between processors (such as microprocessors, communications and network processors, etc.), system memory, peripheral devices, and any other hardware components within a system.

One or more operating systems 510 are stored on one or more of the computer-readable tangible storage devices 508 for execution by one or more of the processors 502 via one or more of the respective RAMs 504 (which typically include cache memory). In the illustrated embodiment, each of the computer-readable tangible storage devices 508 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 102 and devices 105 can also include a R/W drive or interface 514 to read from and write to one or more portable computer-readable tangible storage devices 526.

Computing device 102 and devices 105 can also include a network adapter or interface 516, such as a TCP/IP adapter card or wireless communication adapter (such as a 4G wireless communication adapter using OFDMA technology).

Computing device 102 and devices 105 can also include a display screen 520, a keyboard or keypad 522, and a computer mouse or touchpad 524. Device drivers 512 interface to display screen 520 for imaging, to keyboard or keypad 522, to computer mouse or touchpad 524, and/or to display screen 520 for pressure sensing of alphanumeric character entry and user selections. The device drivers 512, R/W drive or interface 514 and network adapter or interface 516 can comprise hardware and software (stored in computer-readable tangible storage device 508 and/or ROM 506).

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A method, comprising:
collecting activity data concerning a local environment from a device associated with the local environment;
determining, using a processor, an activity state associated with a local environment based on the activity data collected by the device; and
managing, using the processor, an access setting associated with a network port of a network gateway into the local environment based on the activity state.

2. The method of claim 1, wherein the managing further comprises changing the access setting between first and second access levels based on the activity data.

3. The method of claim 1, wherein the device represents a sensor to monitor at least a portion of the local environment and provide, as the activity data, an indication of whether one or more individuals are present in the local environment.

4. The method of claim 1, wherein the device represents a portable device to provide, as the activity data, sleep state information for a user associated with the wearable device.

5. The method of claim 1, wherein the managing further comprises disabling the network port when the activity state corresponds to a sleep state.

6. The method of claim 1, further comprising accessing one or more rules that define the access setting associated with the network port based on the activity state.

7. The method of claim 6, further comprising receiving incoming data traffic from an external source, the data traffic directed to the network port of the network gateway into the local environment, and determining whether to block the data traffic based on the access setting.

8. The method of claim 1, wherein the network gateway includes first and second ports, the managing comprising individually managing the first and second ports to have different access settings based on the activity state.

9. Apparatus, comprising:
a network port into a local environment, the network port to receive data traffic directed to one or more computing devices within a local environment;
memory storing program instructions; and
a processor, in response to execution of the program instructions, to perform the following:
collect activity data concerning the local environment;
determine an activity state associated with a local environment based on the activity data collected by the device; and
manage an access setting for the network port into the local environment based on the activity state.

10. The apparatus of claim 9, further comprising a wireless router, wherein the network port represents a network port on the wireless router.

11. The apparatus of claim 9, wherein the processor, in response to execution of the program instructions, routes incoming data traffic through the network port to a predetermined computing device within the local environment.

12. The apparatus of claim 9, wherein the device represents a portable device that provides, as the activity data, sleep state information for a user associated with the wearable device.

13. The apparatus of claim 9, wherein the device represents a sensor to monitor at least a portion of the local environment and provide, as the activity data, an indication of whether one or more individuals are present in the local environment.

14. The apparatus of claim 9, wherein the processor, in response to execution of the program instructions, changes the access setting between first and second access levels based on the activity data.

15. The apparatus of claim 9, wherein the processor, in response to execution of the program instructions, disables the network port when the activity state corresponds to a sleep state.

16. The apparatus of claim 9, wherein the memory stores one or more rules that define the access setting for the network port based on the activity state.

17. A computer program product comprising a non-signal computer readable storage medium comprising computer executable code to:
collect activity data concerning a local environment from a device associated with the local environment;
determine, using a processor, an activity state associated with a local environment based on the activity data collected by the device; and
manage, using the processor, an access setting associated with a network port of a network gateway into the local environment based on the activity state.

18. The computer program product of claim 17, wherein the manage further comprises to change the access setting between first and second access levels based on the activity data.

19. The computer program product of claim 17, wherein the device represents a portable device to provide, as the activity data, sleep state information for a user associated with the wearable device.

20. The computer program product of claim 17, wherein the manage further comprises to disable the network port when the activity state corresponds to a sleep state.
